(19) United States
(12) Patent Application Publication
(10) Pub. No.: US 2023/0235684 A1
(43) Pub. Date: Jul. 27, 2023

(54) Heat Engine and Method of Manufacture

(71) Applicant: Katrick Technologies Limited, Glasgow (GB)

(72) Inventor: Karthikeyan Velayutham, Glasgow (GB)

(21) Appl. No.: 18/001,326

(22) PCT Filed: Dec. 22, 2020
(86) PCT No.: PCT/GB2020/053348

§ 371 Date: Dec. 9, 2022

(30) Foreign Application Priority Data
Jun. 11, 2020 (GB) 2008912.4

(51) Int. Cl. F01K 27/00

(52) U.S. Cl. CPC F01K 27/00

(57) ABSTRACT

A heat engine is disclosed. The heat engine comprises a housing, a first liquid and a second liquid located within the housing. The first liquid has a higher density and lower boiling point than the second liquid. The heat engine further comprises a heat exchanger which transfers heat to the first liquid to evaporate the first liquid to form a first liquid vapour. The heat engine also comprises at least one fluid flow member which to moves in response to a fluid flow created by the interaction of the first liquid vapour and the second liquid. The liquid-gas phase change of the first fluid provides an alternative mechanism for converting heat into work with numerous advantages. The heat engine has minimal moving parts, a relatively long lifetime, does not require a specific fuel, does not directly release toxic or un-environmentally friendly gases, and can be adapted to a specific source of waste heat.

The present invention relates to a heat engine and method of manufacture. In particular, the described heat engine utilises a phase change of a fluid to convert thermal energy to mechanical energy.

### BACKGROUND TO THE INVENTION

A heat engine is a cyclic device which converts heat into work, or in other words, thermal energy into mechanical energy. In general, a heat engine contains a working substance, such as a gas or fluid, that absorbs heat from a high temperature reservoir, does work on its surrounding and releases heat as it returns to its initial state. There exist numerous different types of heat engines known in the art which operate on this basic principle, such as an internal combustion engine.

The working substance of a heat engine cyclically undergoes changes in pressure, temperature, and volume as well as the addition and removal of heat. For example, within an internal combustion engine, a gas comprising a fuel-air mixture is compressed and then ignited causing the gas to subsequently expand and drive a piston. The motion of the piston if configured to expel the ignited gas and draw in unignited gas for the cycle to continue.

Despite their ubiquitous use, there are numerous disadvantages to an internal combustion engine. An internal combustion engine requires a fuel to operate and cannot operate on waste heat from an external high temperature (T_{H}) source. It is necessary to ignite the fuel to drive a piston which creates noise and requires numerous moving components. These components can degrade and fail with use over time, requiring regular maintenance and ultimately limiting the lifetime of the engine. Furthermore, a suitable fuel for an internal combustion engine is typically limited to expensive, refined gaseous or liquid hydrocarbon compounds. In addition, the combustion of the fuel results in undesirable toxic and environmentally unfriendly gases. Internal combustion engines are also not scalable and so are not suitable for large scale power generation.

An external combustion engine operates by an external high temperature (T_{H}) source heating a working fluid through a heat exchanger or engine wall. The heat causes the working fluid to expand driving a piston. External combustion engines, such as steam engines, can exploit numerous types of heat sources and such engines are widely used. Nevertheless, these engines are typically suited to large scale power production so are large, heavy, expensive devices, which can be unsafe and relatively inefficient. An external combustion engine also comprises moving components which creates noise and requires maintenance.

### SUMMARY OF THE INVENTION

It is an object of an aspect of the present invention to provide a heat engine that obviates or at least mitigates one or more of the aforesaid disadvantages of the heat engines known in the art.

According to a first aspect of the present invention there is provided a heat engine comprising:
a housing;
a first liquid and a second liquid located within the housing, the first liquid having a higher density and lower boiling point than the second liquid;
a heat exchanger to transfer heat to the first liquid to evaporate the first liquid to form a first liquid vapour; and
at least one fluid flow member to move in response to a fluid flow created by the interaction of the first liquid vapour and the second liquid.

Most preferably, the housing is sealable. The heat engine is a closed heat engine. In this arrangement the first and or second liquids are not added and or removed during operation.

Preferably, the first and second liquids occupy an interior volume of the housing. The first and second liquids may mix within the interior volume of the housing.

Preferably, the first liquid is located within a first portion of the housing. The second liquid is located within a second portion of the housing.

Most preferably, the first liquid is de-mineralised water and the second liquid is Xylene. Alternatively, the first liquid is de-mineralised water and the second liquid is kerosene. Alternatively, the first liquid is decafluoropentane and the second liquid is de-mineralised water. Alternatively, the first liquid is chloroform and the second liquid is de-mineralised water.

Preferably, an operating temperate range of the heat engine is between 110 to 150° C. Alternatively, the operating temperature range of the heat engine is between 70 to 90° C.

Preferably, the heat exchanger transfers heat from an external high temperature heat source to the first liquid.

Preferably, the heat exchanger is the first portion of the housing. Alternatively, the heat exchanger is a pipe. The pipe may pass through the first portion of the housing.

Optionally, the heat engine may further comprise one or more pellets. The one or more pellets are located within the interior volume of the heat engine. The one or more pellets are suspended within the first liquid and or second liquid. The density of the one or more pellets is between the density of the first liquid and second liquid. The pellets are chemically unreactive with the first liquid, second liquid, and or first liquid vapour. Preferably, the pellets are magnetically neutral. Alternatively, the pellets are magnetic.

Most preferably, the at least one fluid flow member may take the form of one or more rods. The one or more rods may comprise a first end and a second end. The first ends of the one or more rods are preferably mounted to an interior surface of the housing. The one or more rods may extend into the interior volume of the housing. The second ends of the one or more rods are preferably free to move. The second ends of the one or more rods are preferably located towards a central axis of the housing.

Preferably, the one or more rods are uniformly distributed about the interior surface. Alternatively, the one or more rods are non-uniformly distributed about the interior surface.

Preferably, the one or more rods are orientated perpendicular to the interior surface. Alternatively, the one or more rods are orientated non-perpendicular to the interior surface.

Preferably, the one or more rods are uniformly dimensioned. Alternatively, the one or more rods are non-uniformly dimensioned.

Preferably, the one or more rods comprise the same material composition. The one or more rods may comprise brass. Alternatively, the one or more rods comprise different material compositions.

Optionally, the at least one fluid flow member may take the form of one or more plates. The one or more plates preferably comprise one or more perforations. The one or more plates are preferably dimensioned in the form of a circular cross-section of the housing. The one or more plates may be mounted to the interior surface of the housing. The one or more plates may intersect the central axis of the housing.

Optionally, the at least one fluid flow member may take the form of one or more diaphragms. The one or more diaphragms may comprise one or more perforations.

Optionally, the at least one fluid flow member may take the form of one or more pellets. The one or more pellets are magnetic.

Preferably, the housing comprises an inlet port and an outlet port. The inlet and outlet ports are preferably sealable.

Optionally, the heat engine further comprises a condensing loop. The condensing loop transfers heat to an external low temperature heat sink or source from the first liquid vapour. The condensing loop preferably condenses the first liquid vapour and returns the first liquid to the first portion of the housing.

Optionally, the heat engine further comprises a sink. The sink may comprise the first liquid. The sink is preferably connected to the housing. The sink maintains the level of the first liquid within the first portion of the housing.

According to a second aspect of the present invention there is provided an energy harvesting system comprising a heat engine in accordance with the first aspect of the present invention, an energy conversion means and an external high temperature heat source.

Optionally, the energy harvesting system may further comprise an external low temperature heat sink or source.

Most preferably, the energy harvesting system may further comprise a vibrational lens.

Preferably, the vibrational lens comprises at least two focusing members, each of the at least two focusing members having a first end for attachment to a source of vibration and a second end, wherein the at least two focusing members are arranged such that the separation between the focusing members decreases from the first ends towards the second ends.

Most preferably, the at least two focusing members each comprise a first portion located between the first end and second end. The first portions of the at least two focusing members are angled relative to each other such that the at least two focusing members converge at the second ends.

Preferably, the at least two focusing members each comprise a second portion located at the first end. Preferably, the second portions of the at least two focusing members are substantially parallel.

Most preferably, the vibrational lens further comprises a backplate. The first ends of the at least two focusing members may be fixed to the backplate. The second portions of the at least two focusing members may be fixed to the backplate.

Preferably, the at least two focusing members each comprise a third portion located at the second end. The third portions of the at least two focusing members are substantially parallel. The third portions of the at least two focusing members define a focal point of the vibrational lens.

Preferably, the at least two focusing members comprise brass.

Optionally, the at least two focusing members comprise two or more layers and or coatings. The two or more layers and or coatings may exhibit different vibrational and or thermal characteristics. The at least two layers and or coatings may comprise different dimensions, materials, densities and or grain structures.

Optionally, the at least two focusing members comprise a first layer and a second layer. The first layer is fixed to the second layer. The first layer may comprise brass. The second layer may comprise steel.

Optionally, the vibrational lens further comprises one or more springs. The one or more springs connect the at least two focusing members.

Optionally, the vibrational lens further comprises one or more weights attached to one or more of the at least two focusing members.

Optionally, the vibrational lens further comprises a dynamic control system. The dynamic control system changes the vibrational characteristics of the vibrational lens during operation. The dynamic control system may adjust the stiffness of the spring. The dynamic control system may adjust the location and or magnitude of the weights.

Optionally, the vibrational lens may comprise three focusing members.

Most preferably, the focusing members are focusing plates.

Alternatively, the focusing members are focusing rods.

Most preferably, the first end of the vibrational lens is fixed to the heat engine.

Most preferably, the energy conversion means is located at the second end of the vibrational lens. Preferably, the energy conversion means is located between the third portions of the at least two focusing members.

Optionally, the housing of the heat engine further comprises sealable openings. The rods of the heat engine are directly connected to the focusing members of the vibrational lens. The rods pass through the sealable openings.

Preferably, the energy conversion means is one or more piezoelectric crystals. Additionally or alternatively, the energy conversion means is one or more nano-coils; and or one or more coils.

Alternatively, the energy conversion means is a coil. The coil may be wound around the housing of the heat engine.

Embodiments of the second aspect of the invention may comprise features to implement the preferred or optional features of the first aspect of the invention or vice versa.

According to a third aspect of the present invention there is provided a method of manufacturing a heat engine comprising,
providing a housing,
providing a first liquid and a second liquid located within the housing, the first liquid having a higher density and lower boiling point than the second liquid;
providing a heat exchanger to evaporate the first liquid to form a first liquid vapour; and
providing at least one fluid flow member that moves in response to a fluid flow created by the interaction of the first liquid vapour and the second liquid.

Preferably, the method of manufacturing a heat engine may further comprise determining the characteristics of an external high temperature heat source.

Preferably, determining the characteristics of the external high temperature heat source may include determining the temperature, energy, power, variability and or duration of the external high temperature heat source.

Preferably, the method of manufacturing a heat engine may further comprises determining optimum parameters of a heat engine for use with the external high temperature heat source.

Preferably, determining the optimum parameters of a heat engine for use with the external high temperature heat source may further comprise utilising the characteristics of the external high temperature heat source.

Preferably, determining the optimum parameters of a heat engine may comprise determining: the dimensions of the heat engine; the volume, relative ratio and chemical composition of the first and second liquids; the distribution, orientation, dimensions and or material composition of the at least one fluid flow member; the operational proximity of the heat engine to the high temperature (T_{H}) heat source; if a condensing loop is required; and if a sink is required.

Embodiments of the third aspect of the invention may comprise features to implement the preferred or optional features of the first and or second aspect of the invention or vice versa.

According to a fourth aspect of the present invention there is provided a method of manufacturing an energy harvesting system comprising,
providing a heat engine in accordance with third aspect of the present invention;
providing an external high temperature heat source; and
providing an energy conversion means.

Preferably, the method of manufacturing an energy harvesting system comprises providing an external low temperature heat sink or source.

Preferably, the method of manufacturing an energy harvesting system may comprise providing a vibrational lens.

Preferably, providing a vibrational lens comprises,
providing at least two focusing members, each having a first end and a second end; and
arranging the at least two focusing members such that the separation between the at least two focusing members decreases from the first ends towards the second ends.

Preferably, providing a vibrational lens further comprises determining the characteristics of the heat engine.

Preferably, determining the characteristics of the heat engine comprises quantifying any one of the following parameters: the dimensions of the heat engine, the dimensions of at least one fluid flow member and the frequency characteristics of any mechanical vibrations.

Preferably, providing a vibrational lens may further comprise determining the optimum parameters of the vibrational lens for use with the heat engine.

Preferably, determining the optimum parameters of a vibrational lens comprises determining an optimum length, width and or depth of the at least two focusing members; and or the optimum separation of the first ends of the at least two focusing members; and or the optimum separation of the second ends of the at least two focusing members; and or the optimum distance for the at least two focusing members to converge; and or the optimum material or materials for the at least two focusing members; and or the optimum coefficient of thermal expansion of the material or materials of the at least two focusing members.

Optionally, determining the optimum parameters may also include: determining the depth of a first layer and a second layer of the at least two focusing plates; the material of the first layer; and the material of the second layer. The first layer may comprise brass. The second layer may comprise steel.

Preferably, providing the heat engine is performed before providing vibration lens.

Optionally, the method of manufacturing a vibrational energy harvesting system may be iterative. The heat engine may be optimised following providing the vibrational lens.

Embodiments of the fourth aspect of the invention may comprise features to implement the preferred or optional features of the first, second and or third aspects of the invention or vice versa.

### BRIEF DESCRIPTION OF DRAWINGS

There will now be described, by way of example only, various embodiments of the invention with reference to the drawings, of which:

FIG. 1 presents a schematic cross-sectional view of a heat engine in accordance with an embodiment of the present invention;

FIG. 2 presents a cutaway perspective view of the heat engine of FIG. 1;

FIG. 3 presents a schematic cross-sectional view of the heat engine of FIG. 1 in operation;

FIG. 4 presents a schematic cross-sectional view of an alternative embodiment of the heat engine of FIG. 1 in operation;

FIG. 5 presents a cutaway perspective view of an alternative embodiment of the heat engine of FIG. 1;

FIG. 6 presents a schematic cross-sectional view of an energy harvesting system comprising the heat engine of FIG. 1;

FIG. 7 presents a perspective view of a vibrational lens employed within the vibrational energy harvesting system of FIG. 6;

FIG. 8 presents a schematic cross-sectional view of the vibrational lens of FIG. 7;

FIG. 9 presents a plot of (a) a voltage generated by a piezoelectric crystal located at a second end of the vibrational lens of FIG. 7, when the vibrational lens is attached to an internal combustion engine and (b) a voltage generated by a reference piezoelectric crystal;

FIG. 10 presents a schematic cross-sectional view of an alternative embodiment of the vibrational lens of FIG. 7;

FIG. 11 presents a schematic cross-sectional view of a further alternative embodiment of the vibrational lens of FIG. 7;

FIG. 12 presents a schematic cross-sectional view of yet another alternative embodiment of the vibrational lens of FIG. 7;

FIG. 13 presents a schematic cross-sectional view an alternative embodiment of the energy harvesting system of FIG. 6;

FIG. 14 presents a flow chart of the method of manufacturing the heat engine of FIG. 1;

FIG. 15 presents a schematic cross-sectional view of an alternative energy harvesting system of FIG. 6;

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION OF THE PREFERRED EMBODIMENTS

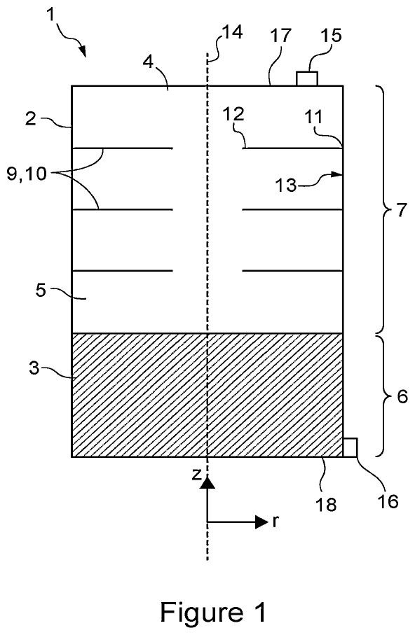

An explanation of the present invention will now be described with reference to FIGS. 1 to 15.

### Heat Engine

FIG. 1 depicts a heat engine 1 comprising a substantially cylindrical, sealable housing 2. The housing 2 comprises stainless steel, specifically, SA516 GR.65. For ease of understanding, FIGS. 1 also depicts a cylindrical coordinate system with r, θ, and z axes.

The heat engine 1 can be seen to comprise a first liquid 3 and a second liquid 4 both of which are located within the housing 2. The first and second liquids 3, 4 occupy an interior volume 5 of the housing 2. The first liquid 3 has a higher density but lower boiling point in comparison to the second liquid 4. As such, whilst the first and second liquids 3, 4 are free to mix within the housing 2, the first liquid 3 locates within a first portion 6 of the housing 2, at the base of the housing 2, and the second liquid 4 locates within a second portion 7 of the housing 2, above the first liquid 3.

By way of example, the first liquid 3 may be de-mineralised water and the second liquid 4 may be Xylene. The density of de-mineralised water is approximately 1.2 times that of Xylene and demineralised water has a boiling point of 100° C. which is lower than the boiling point of Xylene, 138.5° C. De-mineralised water and Xylene are both in a liquid state at room temperature (20° C.) and pressure. A heat engine 1 comprising de-mineralised water and Xylene as the first and second liquids 3, 4 is suitable for operation at a temperature between 110° C. and 150° C.

Further examples of the first and second liquids 3, 4 are provided in Table I along with an operating temperature range of a heat engine 1 comprising the first and second liquids 3, 4. All of the first and second liquids 3, 4 in Table I are in a liquid state at room temperature (20° C.) and pressure. Furthermore, it will be appreciated that different operating temperature ranges to those detailed in Table I, such as an operating temperature range lower than 70-90° C., could be achieved by using different first and second liquids 3, 4 and different combinations of the first and second liquids 3, 4 beyond the disclosed liquids and combinations in Table I.

TABLE I
Examples of the first liquid, second liquid and an operating temperature
range of a heat engine comprising the first and second liquids

| | | Operating Temperature |
|---|---|---|
| First Liquid | Second Liquid | Range (° C.) |
| De-mineralised water | Xylene | 110-150 |
| De-mineralised water | Kerosene | 110-150 |
| Decafluoropentane | De-mineralised water | 70-90 |
| Chloroform | De-mineralised water | 70-90 |

The heat engine 1 also comprises a heat exchanger which transfers heat from an external high temperature (T_{H}) heat source 8 to the first liquid 3 in order to evaporate a quantity of the first liquid 3. The first liquid 3 is not directly exposed to the external high temperature (T_{H}) heat source or any external fluid carrying heat from the external high temperature (T_{H}) heat source 8. In the embodiment of FIG. 1, the heat exchanger takes the form of the first portion 6 of the housing 2.

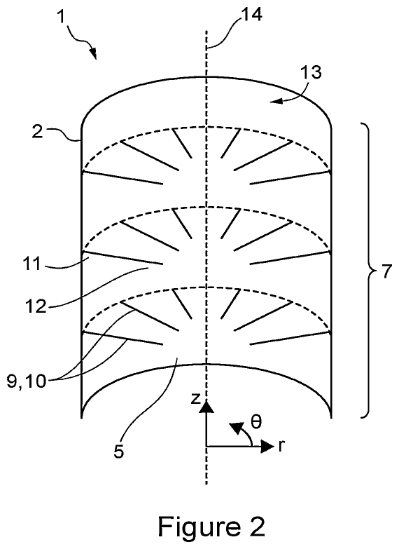

The heat engine 1 further comprises at least one fluid flow member 9. As can be clearly seen in FIG. 2, the at least one fluid flow member takes the form of rods 10. Each rod 10 has a first end 11 and a second end 12. The first ends 11 of the rods 10 are mounted to an interior surface 13 of the housing 2. The rods 10 extend into the interior volume 5 of the housing 2. The second ends 12 of the rods 10 are free to move and are located towards a central axis 14 of the housing 2. The rods 10 are distributed across the interior surface 13 of the housing 2 in both θ and z directions. The rods 10 are located in the second portion 7 of the housing 2. FIGS. 1 to 3 depict the rods 10 as being uniformly distributed about the interior surface 13, orientated perpendicular to the interior surface 13 and all of uniform dimensions such as length. The rods 10 may be made from bronze and or brass as the relatively high density effectively transmits any movement or mechanical vibrations.

The housing 2 comprises a sealable inlet port 15 and a sealable outlet port 16. The sealable inlet port 15 is located at a top end 17 of the housing 2, through the second portion 7 of the housing 2 and provides a means for adding the first and second liquids 3, 4 into the housing 2. Similarly, the sealable outlet port 16 is located, at a base end 18 of the housing 2, through the first portion 6 of the housing 2 and provides a means for draining the first and second liquids 3, 4 from the housing 2. In order to fill and maintain the housing 2 at a positive pressure, the first and second liquids 3, 4 may be pumped to and from the housing 2 by a pumping system 19.

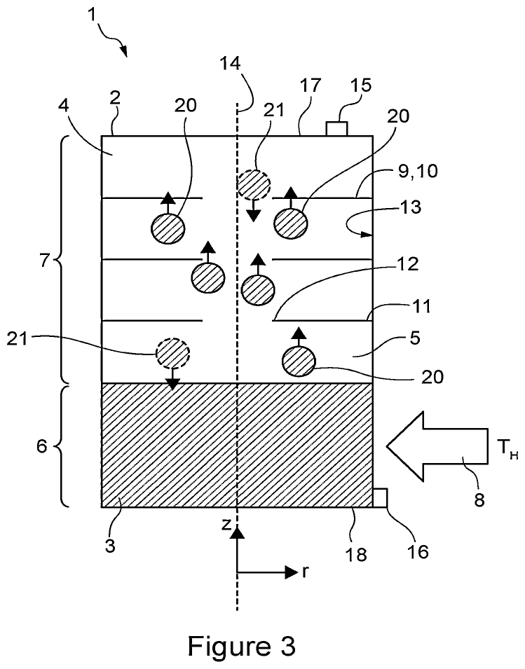

FIG. 3 shows the heat engine 1 of FIG. 1 in operation, in other words converting thermal energy into mechanical energy. The heat engine 1 is a closed engine such that first and second liquids 3, 4 are not added or removed during operation. The first portion 6 of the housing 2 is exposed to the external high temperature (T_{H}) heat source 8 resulting in thermal energy being transferred through the housing 2, to the first liquid 3. As such, a portion of the first liquid 3 evaporates to form a first liquid vapour. The first liquid vapour takes the form of gaseous bubbles 20. The gaseous bubbles 20 have a lower density than both the first liquid 3 and the second liquid 4. As such, the gaseous bubbles 20 move in the positive z-direction, into the second portion 7 of the housing 2 and through the second liquid 4. The thermal energy from the external high temperature (T_{H}) heat source 8 is converted into kinetic energy in the form of the motion of the gaseous bubbles 20.

The interaction, in the form of relative motion and or thermal gradients, of the gaseous bubbles 20 and the second liquid 4 creates a fluid flow. More specifically, the fluid flow includes the flow of the first liquid 3, second liquid 4 and gaseous bubbles 20. For example, the fluid flow is depicted by the arrows in FIG. 3. This fluid flow may be Laminar and or turbulent. The fluid flow induces movement in the rods 10, or more specifically, the fluid flow induces mechanical vibrations within the rods 10. As such, the kinetic energy of the gaseous bubbles 20 is converted into mechanical vibrational energy. For example, the Laminar fluid flow of the gaseous bubbles 20 may result in the gaseous bubbles 20 directly colliding with the rods 10, deflecting the rods 10. Furthermore, the turbulent fluid flow of the gaseous bubbles 20 and second liquid 4 may induce movement and or mechanical vibrations within the rods 10.

Each gaseous bubble 20 dissipates kinetic and thermal energy. As a result, each gaseous bubble 20 will eventually condense to form a liquid bubble 21 of the first liquid 3. The liquid bubbles 21 sink back towards the base end 18, into the first portion 6 of the housing 2 as the density of the liquid bubbles 21 is greater than the density of the second liquid 4. An advantage of the liquid bubbles 21 sinking back through the second portion 7 of the housing 2, is the liquid bubbles 21 may further create fluid flows and induce movement and or mechanical vibrations within the rods 10.

As an alternative embodiment, instead of being cylindrical, it will be appreciated that the housing 2 could take any regular or non-regular three-dimensional shape.

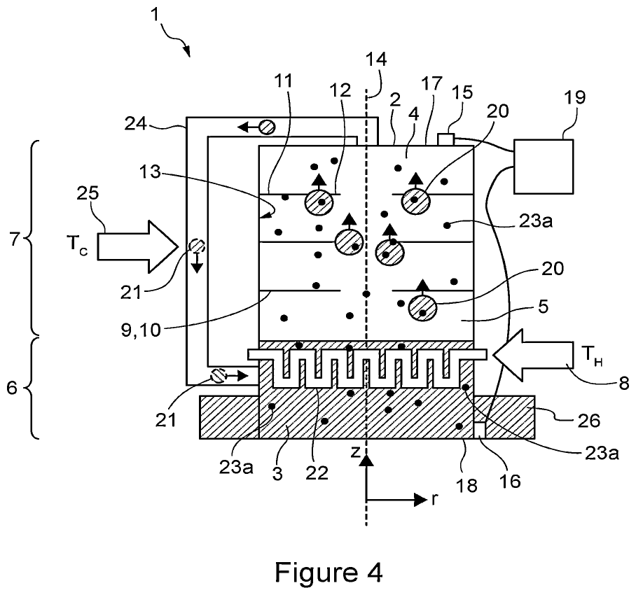

As an additional or alternative embodiment, the heat exchanger may take the form of a pipe 22 which passes through the first portion 6 of the housing 2, see FIG. 4. An external fluid carrying the heat from the external high temperature (T_{H}) heat source 8 passes through the pipe indirectly transferring the heat to the first liquid 3. The pipe 22 is more efficient at transferring heat to the first liquid 3 than through the first portion 6 of the housing 2, as the pipe 22 has greater thermal contact with the first liquid 3.

As an additional or alternative embodiment, the distribution of the rods 10 may be non-uniform. As another additional or alternative embodiment, the rods 10 may be orientated non-perpendicular to the interior surface 13. As a further additional or alternative embodiment, the dimensions of the rods 10, such as the rods length, may vary. As yet another further additional or alternative embodiment, the material composition of the rods 10 may vary. Furthermore, the distribution, orientation, dimensions and material composition of the rods 10 may be computationally optimised.

As an additional or alternative embodiment, the heat engine 1 of FIG. 4, further comprises pellets 23a. The pellets 23a are located within the interior volume 5 of the heat engine 1, suspended within the first and second liquids 3, 4. The pellets 23a move about the interior volume 5 of the housing 2 in response to the fluid flow created by the interaction of the gaseous bubbles 20 and the second liquid 4. The pellets 23a collide with the rods 10 inducing further movement, or more specifically, mechanical vibrations within the rods 10, in addition to the movement induced directly by the fluid flow. The density of the pellets 23a is between the density of the first and second liquids 3, 4 such that the pellets 23a are not too heavy or buoyant when suspended within the first and second liquids 3, 4. Furthermore, the pellets 23a are chemically unreactive with the first liquid 3, second liquid 4 and gaseous bubbles 20. The pellets 23a are also magnetically neutral.

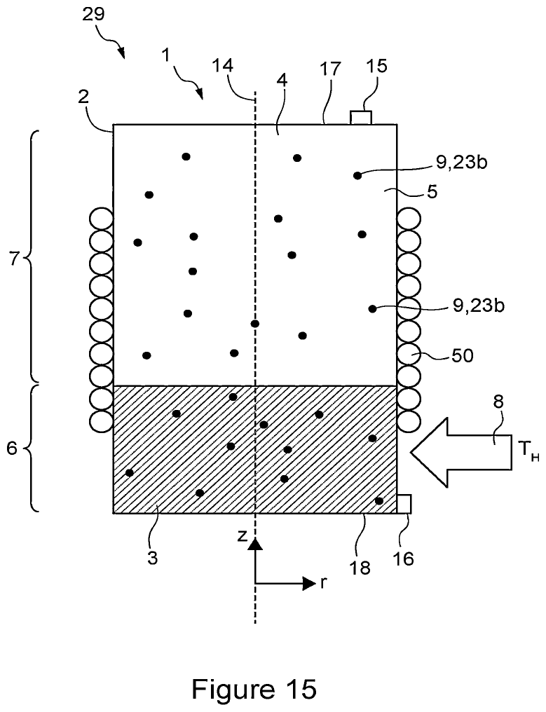

The dimensions and material composition of the pellets 23a may be optimised to achieve the desired interaction with the fluid flow. As a further additional or alternative embodiment, the pellets 23b may be magnetic, as discussed further below in the context of FIG. 15.

As an additional or alternative embodiment, the heat engine 1 of FIG. 4, further comprises a condensing loop 24. Instead of the gaseous bubbles 20 passively condensing once they have lost sufficient energy within the housing 2, the condensing loop 24 actively condenses the gaseous bubbles 20. More specifically, once the gaseous bubbles 20 have traversed through the second portion 7 of the housing 2, the gaseous bubbles 16 pass through the condensing loop 24 where an external low temperature (T_{L}) heat sink or source 25 actively cools the gaseous bubbles 20 such that they condense to liquid bubbles 21. The liquid bubbles 21 are returned to the first portion 6 of the housing 2. A condensing loop 24 may be advantageous if, for example, the gaseous bubbles 20 accumulate at the top end 17 of the housing 2.

As another additional or alternative feature, the heat engine 1 of FIG. 4, further comprises a sink 26 of the first liquid 3. The sink 26 is connected to the housing 2 and maintains the level of the first liquid 3 within the first portion 6 of the housing 2. As the first liquid 3 evaporates within the heat engine 1, this may induce non negligible changes in pressure and or volume within the heat engine 1. The sink 26 minimises any changes in pressure and or volume.

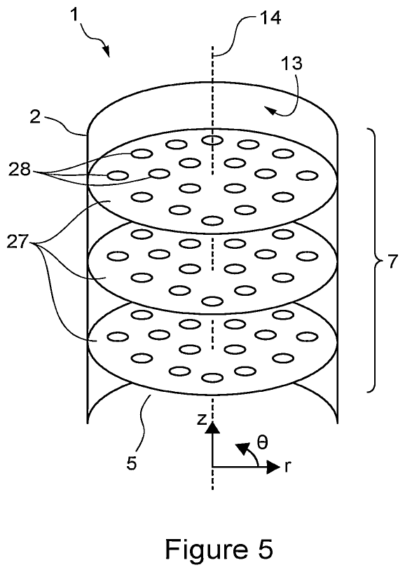

As an additional or alternative embodiment, instead of the rods 10, the at least one fluid flow member may take the form of a plate 27 comprising perforations 28, as depicted in FIG. 5. The plate 27 is dimensioned in the form of a circular cross-section of the housing 2, mounted to the interior surface 13 of the housing 2 and orientated to intersect the central axis 14. The fluid flow induces movement and or mechanical vibrations within the plate 27. For example, the fluid flow of the gaseous and liquid bubbles 20, 21 are blocked by the plate 27 and redirected through the perforations 28 inducing movement and or mechanical vibrations in the plate 27. The size, distribution and relative location of the perforations 28 can be optimised to enhance the turbulent fluid flows within the heat engine 1. As a further additional or alternative feature, the plate 27 may be flexible, in other words, the fluid flow member takes the form of a diaphragm with perforations.

The process of heat transfer to the first liquid 3, evaporation of the first liquid 3 to form gaseous bubbles 20, energy transfer from the gaseous bubbles 20 to the fluid flow member (in other words the rods 10, plate 27 and or diaphragm) and condensation of the gaseous bubbles 20 to form liquid bubbles 21 is repeated forming a cycle. The mechanical energy (in other words the movement and or vibrations) can be further converted into electrical energy.

### Energy Harvesting System

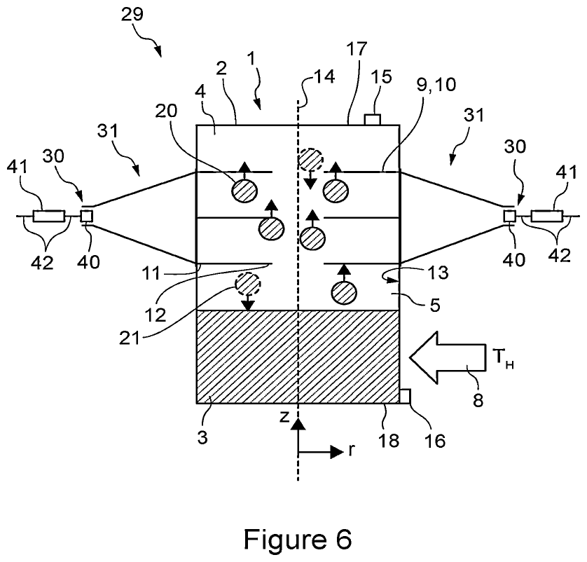

FIG. 6 depicts the heat engine 1 and the external high temperature (T_{H}) heat source 8 as part of an energy harvesting system 29, more specifically, a vibrational energy harvesting system. The vibrational energy harvesting system 29 further comprises an energy conversion means 30. The energy harvesting system may optionally comprise the external low temperature (T_{L}) heat sink or source 25 if required to condense the gaseous bubbles 20. Furthermore, the vibrational energy harvesting system 29 may optionally comprise a vibrational lens 31.

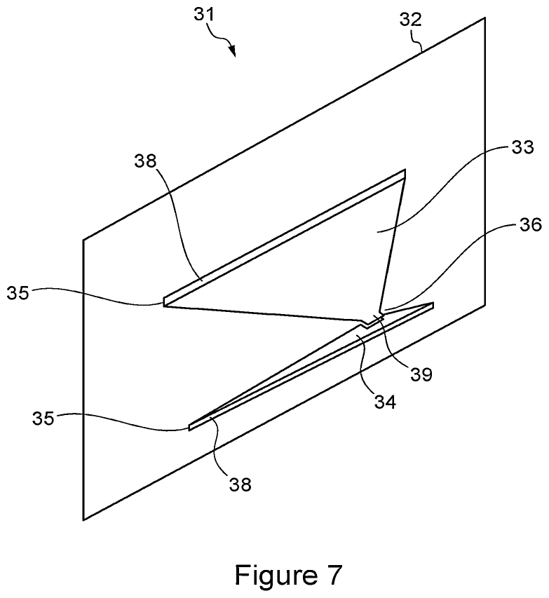

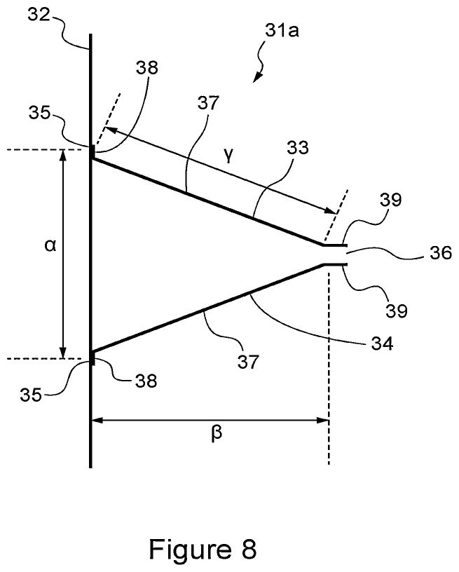

FIGS. 7 and 8 depict a suitable vibrational lens 31a for use in the energy harvesting system 29. The vibrational lens 31a may be of a type as described in the applicant's co-pending UK patent application number GB1911017.0. As such, the vibrational lens 31a comprises a backplate 32 and two focusing members. The focusing members take the form of a first focusing plate 33 and a second focusing plate 34. The first and second focusing plates 33, 34 each have a first end 35 and a second end 36. The first and second focusing plates 33, 34 each comprise a first portion 37, having a length y, located between a second portion 38, at the first end 35, and a third portion 39, at the second end 36.

The second portion 38 of the first and second focusing plates 33, 34 is fixed to the backplate 32. As shown in FIG. 7, the second portion 38 is angled to be substantially parallel and in contact with the backplate 32 such that the second portion 38 is fixed to the backplate 32 by welding. In addition to or as an alternative to welding, the fixture means may take the form of an adhesive, a nut and a bolt, rivets, a combination thereof or any other suitable alternative.

The second portions 38 of the first and second focusing plates 33, 34 are fixed to the backplate 32 at substantially the same orientation and separated by distance α, as can be seen in FIG. 8.

As can also be seen in FIG. 8, the first portions 37 of the first and second focusing plates 33, 34, are angled relative to the backplate 32 such that they converge towards each other. In the presently described embodiment, the first portions 37 of the first and second focusing plates 33, 34, are angled relative to the backplate 32 such that they converge towards a point at a distance β along a normal to the backplate 32 located midway (α/2) between the second portions 38 of the first and second focusing plates 33, 34.

The third portions 39 at the second end 36 of the first and second focusing plates 33, 34 are angled to be substantially parallel, and preferably perpendicular to the backplate 32, and act as the focal point of the vibrational lens 31a.

As depicted in FIGS. 6, the vibrational lens 31a is attached to the heat engine 1. The backplate 32 of the vibrational lens 31a is fixed to the heat engine 1, by for example nuts and bolts, welding and or any other appropriate, equivalent means or combination thereof. Mechanical vibrations induced in the rods 10 of the heat engine 1 are transmitted through the housing 1 of the heat engine 1 to the vibrational lens 31a.

As can clearly be seen in FIG. 6, located between the third portions 39 of the first and second focusing plates 33, 34 is the energy conversion means 30 which takes the form of one or more piezoelectric crystals 40. The piezoelectric crystals 40 are connected to electrical components 41 and directed to, for example, an appropriate electrical load (not shown) by cables 42. The one or more piezoelectric crystals 40 convert vibrational mechanical energy originating from the heat engine 1 into useful electrical energy. An alternative energy conversion means could take the form of nano-coils and magnets.

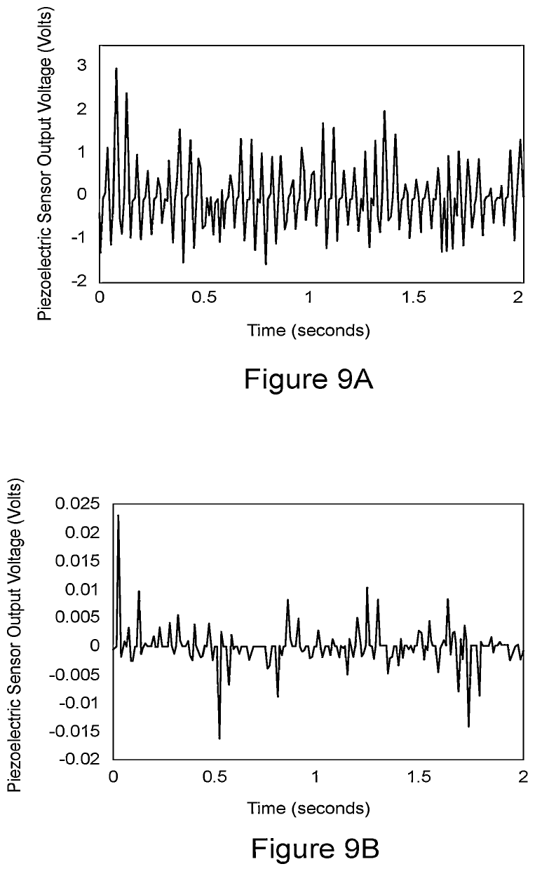

It will be appreciated that in an additional or alternative embodiment of the energy harvesting system 29, the piezoelectric crystals 40 may be attached directly to the heat engine 1. However, in the embodiment as depicted by FIG. 6, the piezoelectric crystals 40 are attached to the vibrational lens 31 as more electrical energy can be generated, as generically demonstrated by FIG. 9.

FIG. 9a shows the voltage as a function of time, generated by a piezoelectric crystal 40 located between the third portions 39 of the first and second focusing plates 33, 34 of the vibrational lens 31a when the vibrational lens 31a is attached to an internal combustion engine which acts as a vibrational source, taking the place of the heat engine 1. FIG. 9a depicts a root mean-square voltage of 0.743 V. FIG. 9b shows the voltage as a function of time, generated by a reference piezoelectric crystal (not shown in the Figures) directly attached the internal combustion engine. FIG. 9b depicts a root mean-square voltage 0.003 V. The piezoelectric crystal 40 between the third portions 39 generates a voltage approximately 248 times greater than the voltage of the reference piezoelectric crystal.

The reason for this is that vibrational lens 31a transmits, converges and focuses vibrations from the first end 35 to the second end 36 of the focusing plates 33, 34. As such, the focusing plates 33, 34 could be considered equivalent to a cantilever as the first end 35 of each focusing plate 33, 34 is fixed to the backplate 32, and the second end 36 is free to move, actuating the piezoelectric crystals 40.

The focusing plates 33, 34 are substantially triangular, as can clearly be seen in FIG. 7. The first end 35 of the focusing plates 33, 34 are equivalent to the base of a triangle and the second end 36 equivalent to the (truncated) tip of a triangle. The triangular shape of the focusing plates 33, 34 minimises the space required to house the vibrational lens 31a at the perpendicular distance β from backplate 32 whilst maintaining functionality.

The vibration lens 31a as depicted in FIGS. 6 to 8 is made from brass due to the relatively high density of brass which facilitates efficient transmission of vibrational mechanical energy through the vibrational lens 31a. The vibrational lens 31a may alternatively be made from other metals, alloys or even non-metallic materials, such as ceramics, suitable for transmitting vibrational energy.

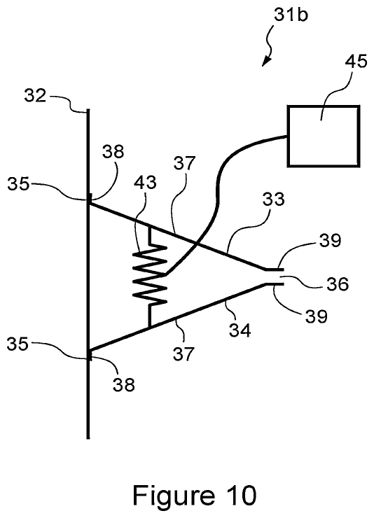

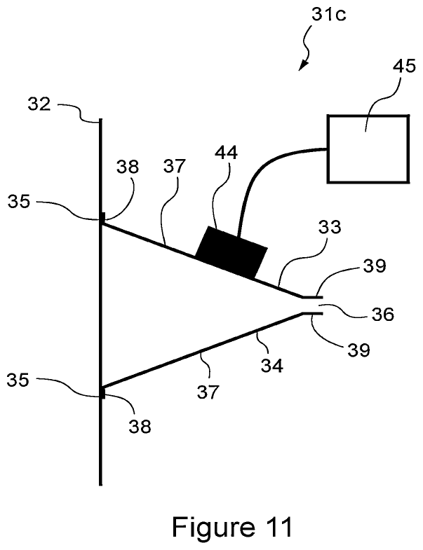

As an additional or alternative feature, the vibrational lens 31b of FIG. 10, further comprises a spring 43 between the first and second focusing plates 33, 34. It will be appreciated that the vibrational lens 31b could comprise multiple springs 43. Similarly, as a further additional or alternative feature the vibrational lens 31c of FIG. 11, further comprises a weight 44 attached to the first focusing plates 33. Again, it will be appreciated that the vibrational lens 31c may comprise multiple weights 44 of equal or non-equal weight located on both or just one of the first and second focusing plates 33, 34. As a further alternative the vibrational lens 31 may comprise both a spring 43 and a weight 44. Both the spring 43 and the weight 44 modify the vibrational characteristics of the vibrational lens 31b, 31c by damping and or changing the resonant frequency of the vibrational lens 31b, 31c, which provides a mechanism to optimise the characteristics of the vibrational lens 31b, 31c. FIGS. 10 and 11 show the vibrational lens 31b, 31c may additionally comprise a dynamic control system 45 to dynamically adjust the stiffness of the spring 43 and or location of the weight 44 on the first and or second focusing plates 33, 34 and or the magnitude of the weight 44 on the first and or second focusing plates 33, 34. For example, the weight 44 may take the form of a container into which water may be pumped in and or out of by means of the dynamic control system 45. The dynamic control system 45 facilitates modifying the vibrational characteristics of the vibrational lens 31b, 31c during operation.

As another additional or alternative feature, the focusing members may comprise multiple layers and or coatings. The different layers and or coatings may exhibit different vibrational and or thermal characteristics due to comprising, for example, different dimensions, materials, densities and or grain structures.

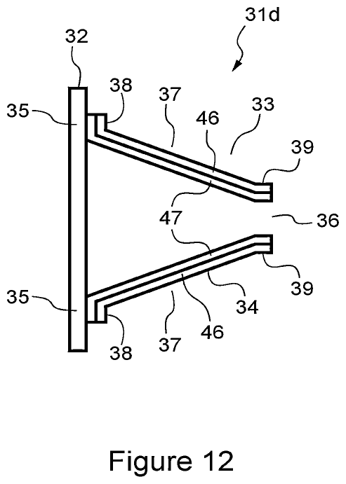

For example, FIG. 12 depicts focusing plates 33, 34 comprising a first, outer layer 46 and a second, inner 47 layer. The second, inner layer 47 may be less dense than the first, outer layer 46. It is found this arrangement improves the transmission of vibrations through the vibrational lens 31d. As another example, the grain structure of the first, outer layer 46 may be more aligned in comparison to the grain structure of the second, inner layer 47. Again, this arrangement improves the transmission of vibrations through the vibrational lens 31d. As another example, the first layer 46 may be made from brass and the second layer 47 may be made from steel.

In addition, it is further noted the relative physical properties of the first, outer layer 46 and the second, inner layer 47 may be reversed such that, for example, the second, inner layer 47 may be more dense than the first, outer layer 46. As a further alternative, the grain structure of the first, outer layer 46 may be less aligned in comparison to the grain structure of the second, inner layer 47. The physical properties of the different layers such as the dimensions, materials, densities and or grain structures are optimised according to the desired vibrational and or thermal characteristics which ultimately depends on frequency characteristics of the vibrational source, in other words, the heat engine 1.

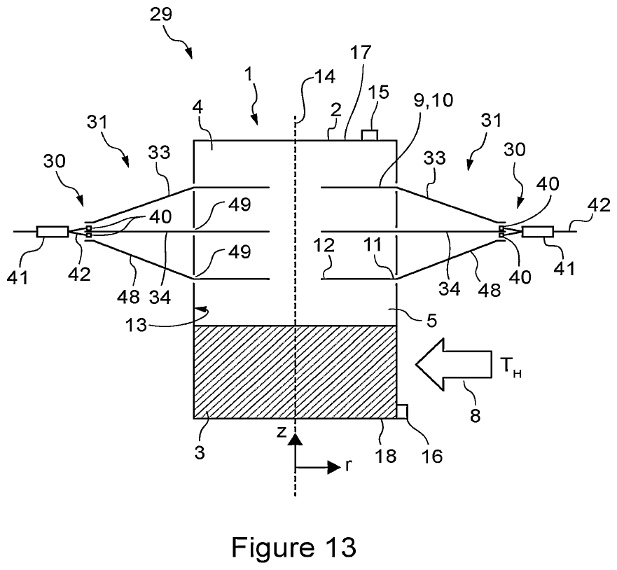

As a further alternative, the vibrational lens 31a, 31b, 31c, 31d may comprise more or less than two focusing plates 33, 34. For example, a vibration lens 31a, 31b, 31c, 31d with just a first focusing plate 33 could actuate piezoelectric crystals 40 located at the second end 36 of the first focusing plate 33 against the heat engine 1, more specifically, a protruding portion of the housing 2. Conversely, a vibrational lens, 31a, 31b, 31c, 31d with three focusing plates 33, 34 may comprise two sets of piezoelectric crystals 40, one set of piezoelectric crystals 40 between the second end 36 of a first and a second focusing plates, and the other set of piezoelectric crystals between the second 34 and third 48 focusing plates, as shown in FIG. 13.

As yet another alternative, instead of the vibrational lens 31a, 31b, 31c, 31d comprising a backplate 32, the focusing plates 33, 34 may be fixed directly to the heat engine 1.

FIG. 13 shows another additional or alternative embodiment, where the housing 2 of the heat engine 1 may comprises sealable openings 49 such that the rods 10 pass through the housing 2 and directly connect to the focusing plates 33, 34 of the vibrational lens 31a, 31b, 31c, 31d. As such, the mechanical vibrations induced in the rods 10 can propagate along the rods 10 and directly along the focusing plates 33, 34 of the vibrational lens 31a, 31b, 31c, 31d. In this embodiment, as the rods 10 connect directly to the focusing plates 33, 34, a backplate 32 is not required. The openings 49 are sealable, with or without the rods 10 passing through the openings 49, to ensure the housing 2 does not leak.

As a further alternative, instead of the vibrational lens 31a, 31b, 31c, 31d comprising focusing plates 33, 34, the focusing members could take the form of focusing rods. The focusing rods may just be an extension of the rods 10 of the heat engine 1. Furthermore, the planar layers 46, 47 of the focusing plates 33, 34 as depicted in FIG. 12 are equivalent to concentric layers and or coatings of a focusing rod. Advantageously, focusing rods take up less space than the focusing plates 33, 34.

### Method of Manufacturing a Heat Engine

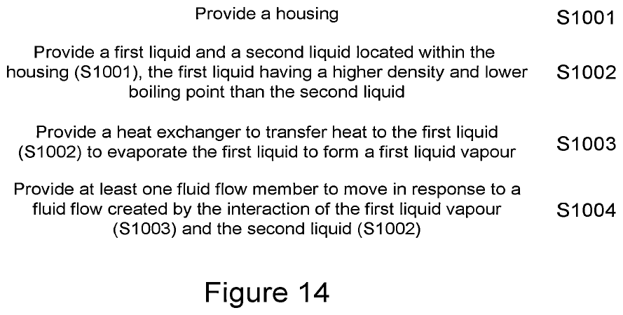

FIG. 14 shows a flow chart for a method of manufacturing the heat engine 1. The method comprises: providing a housing (S1001); providing a first and second liquid located within the housing, the first liquid having a higher density and lower boiling point than the second liquid (S1002); providing a heat exchanger to transfer heat to the first liquid to evaporate the first liquid to form a first liquid vapour (S1003); and providing at least one fluid flow member to move in response to a fluid flow created by the interaction of the first liquid vapour and second liquid (S1004).

In addition, the method of manufacturing the heat engine 1 may optionally comprise characterising the external high temperature (T_{H}) heat source 8. For example, this may include characterising the temperature, energy, power, variability and or duration of the external high temperature (T_{H}) heat source 8. In the context of the present invention, the term high temperature (T_{H}) broadly refers to any temperature above ambient temperature.

As a further addition, the method of manufacturing the heat engine 1 may optionally comprise utilising the characteristics of the high temperature (T_{H}) heat source 8 to determine the optimum parameters of a heat engine 1. For example, this optimisation process may include determining: the dimensions of the heat engine 1; the volume, relative ratio and chemical composition of the first and second liquids 3, 4; the distribution, orientation, dimensions and material composition of the rods 10; the operational proximity of the heat engine 1 to the high temperature (T_{H}) heat source 8; if a condensing loop 24 is required; and if a sink 26 is required. As an example of the parameter dependency, the higher the temperature and power of the external high temperature (T_{H}) heat source 8, the greater the maximum viable size (i.e. dimensions, volume) of the heat engine 1. When choosing the first and second liquids 3, 4 factors such as the heat capacity, relative density and relative boiling points are key considerations. It is advantageous to optimise the heat engine 1 as this ensures the heat engine 1 can operate, for example, the external high temperature (T_{H}) heat source 8 will provide enough heat to evaporate any quantity of the first liquid 3. Furthermore, the optimisation ensures the heat engine 1 can operate efficiently.

### Method of Manufacturing a Vibrational Energy Harvesting System

A method of manufacturing an energy harvesting system 29 comprises providing a heat engine 1 in accordance with the flow chart depicted in FIG. 14 and as described above, providing an external high temperature (T_{H}) heat source 8 and providing an energy conversion means 30.

As an additional or alternative feature, the method of manufacturing an energy harvesting system 29 may optionally comprise providing an external low temperature (T_{L}) heat sink or source 25.

As a further additional or alternative feature, the method of manufacturing an energy harvesting system 29 may optionally comprise providing a vibrational lens 31a, 31b, 31c 31d. The vibrational lens 31a, 31b, 31c 31d is manufactured such that it is optimised for a specific heat engine 1. Providing a vibration lens 31a, 31b, 31c 31d may comprise, determining the characteristics of the heat engine 1 such as the dimensions of the heat engine 1, the dimensions of the fluid flow member (i.e. rods 10) and most significantly the frequency characteristics of the mechanical vibrations induced within the rods 10.

In addition, providing a vibrational lens 31a, 31b, 31c 31d may optionally comprise determining the optimum parameters for a vibrational lens 31a, 31b, 31c 31d for harvesting the mechanical vibrational energy from the heat engine 1. This includes determining the shape and dimensions of the vibrational lens 31a, 31b, 31c 31d such as, distances α, β and γ. More specifically, the optimisation may include dimensioning the length γ of the focusing plates 33, 34, to match an average resonant frequency across the operational range of the heat engine 1.

Furthermore, providing a vibrational lens may optionally comprise providing a vibrational lens 31a, 31b, 31c 31d according to the optimum parameters. More specifically, the focusing plates 33, 34 of the vibrational lens 31a, 31b, 31c 31d are provided by water jet cutting brass plates to the required dimensions and introducing appropriate bends in focusing plates 33, 34. The focusing plates 33, 34 are welded to the backplate 32.

Providing a vibrational lens may optionally comprise further optimising the parameters of the vibrational lens 31a, 31b, 31c 31d according to factors such as: the type of energy conversion means located at the second end 36 of the focusing plates 33, 34; the number of focusing plates 33, 34 the vibrational lens 31a, 31b, 31c 31d comprises; the space available to house the vibrational lens 31a, 31b, 31c 31d; and more generally the operational constraints and desired performance characteristics. For example, the first portions 37 of the first and second focusing plates 33, 34 are not limited to converging midway between the second portions 38 of the first and second focusing plates 33, 34. In other words, the first portions 37 of the focusing plates 33, 34 may be asymmetrically angled relative to the backplate 32 to fit within the available space and or for a desired performance of the vibrational lens 31a, 31b, 31c 31d.

As describe above, the heat engine 1 is optimised for a specific external high temperature (T_{H}) heat source 8. Therefore, when manufacturing an energy harvesting system 29 it may be suboptimal to provide the vibrational lens 31a, 31b, 31c 31d without first manufacturing and characterising the heat engine 1. However, it is noted that this method may be iterative. For example, parameters of the heat engine 1 may be altered to optimise the vibrational lens 31a, 31b, 31c 31d and energy harvesting system 29.

### Alternative Heat Engine and Energy Harvesting System

FIG. 15 depicts an alternative heat engine 1 as part of an alternative energy harvesting system 29. The heat engine 1 and energy harvesting system 29 depicted in FIG. 15 may comprise the same preferable and optional features as the heat engine 1 and energy harvesting system 29 depicted in any of FIGS. 1 to 14.

Instead of the at least one fluid flow member 9 taking the form of rods 10, a plate 27 and or a diaphragm, the at least one fluid flow member 9 of the heat engine 1 of FIG. 15 takes the form of at least one magnetic pellet 23b located within the interior volume 5 of the heat engine 1 and suspended within the first and or second liquids 3, 4. The magnetic pellets 23b move about the interior volume 5 of the housing 2 in response to the fluid flow created by the interaction of the gaseous bubbles 20 and the second liquid 4. The thermal energy of the external high temperature (T_{H}) heat source 8 is converted into mechanical energy in the form of motion of the magnetic pellets 23b. In this embodiment it may be preferably for the housing 2 to comprise a non-magnetic material such as Aluminium.

As well as the heat engine 1, the alternative energy harvesting system 29 comprises an external high temperature (T_{H}) heat source 8 and an energy conversion means 30. Instead of piezoelectric crystals 40, the energy conversion means 30 takes the form of a coil 50, wound around the housing 2 of the heat engine 1. The coil 50 may comprise copper although other alternative magnetically inductive materials may be employed. It will also be appreciated by the skilled reader that the location the coil 50 may vary from that shown in FIG. 15. For example the coil 50, or at least a portion of the coil 50, may be located within the housing 2.

The motion of the magnetic pellets 23b within the heat engine 1 induces useful electrical energy within the coil 50. This energy harvesting system 29 relies on magnetic induction instead of mechanical vibrations to harvest the thermal energy originating from the external high temperature (T_{H}) heat source 8.

As an additional or alternative embodiment, the at least one fluid flow member 9 of a heat engine 1 may take the form of both rods 10 and magnetic pellets 23b. The fluid flow created by the interaction of the gaseous bubbles 20 and the second liquid 4, induces both mechanical vibrations within the rods 10 and the motion of the magnetic pellets 23b. Correspondingly, the energy conversion means 30 of an energy harvesting system 29 may be both piezoelectric crystals 40 and a coil 50. The piezoelectric crystals 40 convert the mechanical vibrational energy into useful electrical energy and the motion of the magnetic pellets 23b induces useful electrical energy within the coil 50. As well as inducing electrical energy, the motion of the magnetic pellets 23b may advantageously also collide with the rods 10 inducing further mechanical vibrations.

The heat engine 1 has numerous advantages. The heat engine 1 does not rely on conventional thermodynamic cycles, but instead provides an alternative mechanism of converting heat into work by utilising a phase change of the first liquid 3 to create fluid flows and the subsequent interaction with the rods 10.

The heat engine 1 operates primarily on changes in temperature as well as the addition and removal of heat. Changes in pressure and volume, whilst might be present due to the intrinsic relationship to temperature, are not fundamental to the operation of the heat engine 1. In other words, the heat engine 1 does not reply on the expansion of a gas to perform work. As such, the heat engine 1 has minimal moving components, reducing the amount of maintenance that may be required and maximising the lifetime of the device. Also, as there are minimal moving components, the heat engine 1 is relatively quiet.

The heat engine 1 is not limited to a specific type of fuel so can utilise a variety of external high temperature (T_{H}) heat sources 8 ranging in temperature and power. Depending on the origin of the external high temperature (T_{H}) heat source 8, the heat engine 1 does not result in the release of toxic and un-environmentally friendly gases.

Furthermore, the heat engine 1 is scalable as can be adapted for different external high temperature (T_{H}) heat sources 8 ranging in temperature and power. As such, the dimensions of the heat engine 1 can be adapted to the desired size and resulting expense. The heat engine 1 is a sealed device with minimal moving components so is relatively safe.

The heat engine 1 is customisable as the rods 10 can be optimised for a specific external high temperature (T_{H}) heat source 8.

A heat engine is disclosed. The heat engine comprises a housing, a first liquid and a second liquid located within the housing. The first liquid has a higher density and lower boiling point than the second liquid. The heat engine further comprises a heat exchanger which transfers heat to the first liquid to evaporate the first liquid to form a first liquid vapour. The heat engine also comprises at least one fluid flow member which to moves in response to a fluid flow created by the interaction of the first liquid vapour and the second liquid. The liquid-gas phase change of the first fluid provides an alternative mechanism for converting heat into work with numerous advantages. The heat engine has minimal moving parts, a relatively long lifetime, does not require a specific fuel, does not directly release toxic or un-environmentally friendly gases, and can be adapted to a specific source of waste heat.

Throughout the specification, unless the context demands otherwise, the terms “comprise” or “include”, or variations such as “comprises” or “comprising”, “includes” or “including” will be understood to imply the inclusion of a stated integer or group of integers, but not the exclusion of any other integer or group of integers. Furthermore, unless the context clearly demands otherwise, the term “or” will be interpreted as being inclusive not exclusive.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A heat engine comprising:
a housing;
a first liquid and a second liquid located within the housing, the first liquid having a higher density and lower boiling point than the second liquid;
a heat exchanger to transfer heat to the first liquid to evaporate the first liquid to form a first liquid vapour; and
at least one fluid flow member to move in response to a fluid flow created by the interaction of the first liquid vapour and the second liquid.

2. The heat engine as claimed in claim 1 wherein, the housing is sealable, the heat engine is a closed heat engine, or the housing is sealable and the heat engine is a closed heat engine.

3. The heat engine as claimed in claim 1, wherein the first and second liquids occupy an interior volume of the housing.

4. The heat engine as claimed in claim 1, wherein the first liquid is located within a first portion of the housing and the second liquid is located within a second portion of the housing.

5. The heat engine as claimed in claim 1, wherein the first liquid is de-mineralised water and the second liquid is Xylene, an operating temperate range of the heat engine is between 110 to 150° C., or the first liquid is de-mineralised water and the second liquid is Xylene and an operating temperate range of the heat engine is between 110 to 150° C.

6. The heat engine as claimed in claim 1, wherein the heat exchanger transfers heat from an external high temperature heat source to the first liquid.

7. The heat engine as claimed in claim 1, wherein the heat exchanger is the first portion of the housing, a pipe, or a first portion of the housing and a pipe.

8. The heat engine as claimed in claim 1, wherein the heat engine further comprises one or more pellets, located within the interior volume of the heat engine, suspended within the first liquid and or second liquid, wherein the density of the one or more pellets is between the density of the first liquid and second liquid.

9. The heat engine as claimed in claim 8, wherein the one or more pellets are magnetic.

10. The heat engine as claimed in claim 1, wherein the at least one fluid flow member is one or more rods.

11. The heat engine as claimed in claim 10, wherein the one or more rods comprise a first end and a second end, wherein each first end of the one or more rods is mounted to an interior surface of the housing and each second end of the one or more rods is free to move.

12. The heat engine as claimed in claim 11, wherein the one or more rods are uniformly distributed about the interior surface, the one or more rods are orientated perpendicular to the interior surface, the one or more rods are uniformly dimensioned, the one or more rods comprise the same material composition, or any combination thereof.

13. The heat engine as claimed in claim 1, wherein the at least one fluid flow member is one or more plates, and wherein one or more plates comprise one or more perforations.

14. The heat engine as claimed in claim 1, wherein the at least one fluid flow member is one or more diaphragms, and wherein the one or more diaphragms comprise one or more perforations.

15. The heat engine as claimed in claim 9, wherein the at least one fluid flow member is one or more pellets.

16. The heat engine as claimed in claim 1, wherein the heat engine further comprises a condensing loop, and wherein the condensing loop transfers heat to an external low temperature heat sink or source from the first liquid vapour.

17. The heat engine as claimed in claim 1, wherein the heat engine further comprises a sink, and wherein the sink comprises the first liquid.

18. An energy harvesting system comprising:
a heat engine as claimed in claim 1;
an energy conversion means; and
an external high temperature heat source.

19. The energy harvesting system as claimed in claim 18, wherein the energy harvesting system further comprises an external low temperature heat sink or source.

20. The energy harvesting system as claimed in claim 18, wherein the energy harvesting system further comprises a vibrational lens.

21. The energy harvesting system as claimed in claim 20, wherein the vibrational lens comprises at least two focusing members, each of the at least two focusing members having a first end for attachment to a source of vibration and a second end, wherein the at least two focusing members are arranged such that the separation between the focusing members decreases from the first ends towards the second ends.

22. The energy harvesting system as claimed in claim 21, wherein the at least two focusing members are focusing plates, focusing rods, or focusing rods and focusing plates.

23. The energy harvesting system as claimed in claim 21, wherein the first end of the vibrational lens is fixed to the heat engine and the energy conversion means is located at the second end of the vibrational lens, between third portions of the at least two focusing members.

24. The energy harvesting system as claimed in claim 18, wherein the energy conversion means is one or more piezoelectric crystals, one or more coils; or one or more piezoelectric crystals and one or more coils.

25. A method of manufacturing a heat engine comprising,
providing a housing;
providing a first liquid and a second liquid located within the housing, the first liquid having a higher density and lower boiling point than the second liquid;
providing a heat exchanger to evaporate the first liquid to form a first liquid vapour; and
providing at least one fluid flow member that moves in response to a fluid flow created by the interaction of the first liquid vapour and the second liquid.

26. The method of manufacturing a heat engine as claimed in claim 25, wherein the method of manufacturing a heat engine further comprises determining the characteristics of an external high temperature heat source.

27. The method of manufacturing a heat engine as claimed in claim 25, wherein the method of manufacturing a heat engine further comprises determining optimum parameters of a heat engine for use with the external high temperature heat source.

28. A method of manufacturing an energy harvesting system comprising;
providing a heat engine according to the method of claim 25;
providing an external high temperature heat source; and
providing an energy conversion means.

29. The method of manufacturing an energy harvesting system as claimed in claim 28, wherein the method of manufacturing an energy harvesting system further comprises providing a vibrational lens.

30. The method of manufacturing an energy harvesting system as claimed in claim 29, wherein wherein providing a vibrational lens comprises:
providing at least two focusing members, each having a first end and a second end; and
arranging the at least two focusing members such that the separation between the at least two focusing members decreases from the first ends towards the second ends.
